(19) United States
(12) Patent Application Publication
(10) Pub. No.: US 2003/0217120 A1
(43) Pub. Date: Nov. 20, 2003

(54) Interactive system and method for providing memorial information

(76) Inventors: Michael W. Hickey, O'Fallon, MO (US); Kenneth E. Gouin, O'Fallon, MO (US); Sean B. Cross, Ballwin, MO (US)

Correspondence Address: BLACKWELL SANDERS PEPER MARTIN LLP, TWO PERSHING SQUARE, 2300 MAIN STREET, SUITE 1000, KANSAS CITY, MO, 64108, US

(21) Appl. No.: 10/150,332

(22) Filed: May 17, 2002

(51) Int. Cl. G06F 15/16

(52) U.S. Cl. 709/219; 709/203

(57) ABSTRACT

An interactive electronic system and method for storing and providing memorial information is disclosed. An enclosure that has at least one opening is provided. An interactive user interface for use by the living person is provided, and the interactive user interface is contained within the enclosure. A processor is provided that is configured to receive message information having an associated playback-event information, including an associated playback event. The processor is also configured to provide the message information via the interactive user interface upon an occurrence of the associated playback event. Additionally, a Global Positioning System transmitter and receiver for use in connection with memorial information is provided.

### BACKGROUND OF INVENTION

Some people have desired to express messages after their death to their surviving family and friends. These messages have traditionally taken the form of letters or prerecorded audio or audio/visual messages that are left with a trusted person to be given to the intended recipient of the message at an appropriate time. However, identifying a list of messages to give to a list of recipients at predetermined times can be burdensome on the trusted person, particularly at a time when the trusted person may have other concerns, i.e., grieving or attending to necessary business matters in connection with the death of the deceased person.

Furthermore, it is frequently awkward or inconvenient to repeatedly communicate the instructions and to maintain a catalog of all messages a person would like to communicate after his or her death. Accordingly, there is a need in the art for methods and systems for automatically cataloging and scheduling posthumous or memorial messages.

U.S. Pat. No. 5,404,343 (issued to “Boggio”) discloses a resting-place marker with an audio system. The device comprises a grave stone or tombstone having an audio system contained therein, which can broadcast information relevant to the deceased. The audio information is stored digitally within semiconductor electronics. The device is powered by a photovoltaic panel (solar cell) and/or a battery. The audible broadcast may be an epitaph, music, poems, favorite sayings, stories, voice messages to the world or to loved ones, combinations thereof, and/or anything which can be broadcast via an audio speaker in audible tones or voices. However, Boggio suffers the limitation of not providing video and, further, Boggio does not provide for the storage of specific messages that can be scheduled for transmission at specific points in time.

U.S. Pat. No. 4,169,970 (issued to “Opiela” et al.) discloses a memorial audio reproduction system. The system comprises a housing that is secured within a tombstone. A tape player and an audio tape loop, having a pre-recorded message, are contained within the housing. A person visiting the memorial can activate a switch and listen to an audio recording of the deceased. The device is powered primarily by a battery and, secondarily, by a solar cell. However, Opiela suffers the same limitation of not providing video and, further, Opiela does not provide for the storage of specific messages that can be scheduled for transmission at specific points in time. The Reference merely discloses a system wherein interaction with the tombstone merely plays back a single pre-recorded audio message.

U.S. Pat. No. 5,987,720 (issued to “Yamamoto”) discloses a portable tomb for resurrection from mummified tissue DNA. The device comprises a transparent plastic object that may be cast in a variety of shapes. Embedded within the object is a mummified tissue sample of the deceased. Also, embedded within the object are various mementos of the deceased, including audio recordings of the voice of the deceased and visual images, such as a digitized picture. The device may be powered by a number of means, including solar panels. However, Yamamoto does not disclose structuring the system such that specific messages are played at specific points in time.

Accordingly, there is a need in the art for methods and systems that do not suffer from the limitations of known systems.

### SUMMARY OF INVENTION

This present invention relates to a system and method for providing memorial information. More specifically, the invention relates to an interactive system and method utilized in connection with messages and instructions provided by a person for distributing memorial information at predetermined times.

The memorial apparatus has an enclosure with an opening. The memorial system has an interactive user interface for use by the living person, the interactive user interface being contained within the enclosure. There is also a processor configured to receive message information having associated playback-event information, including an associated playback event. The processor is further configured to provide the message information via the interactive user interface upon an occurrence of the associated playback event. At least a portion of the message information was initially provided by the deceased person.

In one embodiment, the system has an interactive user interface in the form of a Personal Digital Assistant with a touch screen for receiving user input and for providing video output. The Personal Digital Assistant also has an audio output device connected to a loudspeaker.

Optionally, the message information involves audio visual streaming video. Optionally, the message information involves audio information. Optionally, the audio information comprises a voice message recorded in a digital format. Optionally, the digital format is chosen from a Moving Picture Experts Group audio layer three format and a WAV audio format.

In one embodiment, the associated playback event is the occurrence of a birthday. This birthday can include, but is not limited to, that of a surviving user or the deceased. Alternatively, the associated playback event is the occurrence of a wedding anniversary. It is also recognized and contemplated that the playback event could be any date of significance to a an actual or potential user of the memorial system or of significance to a deceased person associated with the interactive memorial.

A Global Positioning System transceiver unit for providing geographical location information is optionally deployed. The Global Positioning System transceiver unit optionally includes a container for holding cremated remains.

### BRIEF DESCRIPTION OF DRAWINGS

These and other inventive features, advantages, and objects will appear from the following Detailed Description when considered in connection with the accompanying drawings in which similar reference characters denote similar elements throughout the several views and wherein:

FIG. 1 illustrates a schematic block diagram of a network in which methods and systems consistent with the present invention may be practiced;

FIG. 2 illustrates a schematic diagram of an exemplary enclosure and an associated enclosure face;

FIG. 3 illustrates a sectional side diagram of one embodiment, including exemplary contents of the enclosure;

FIG. 4 illustrates a block diagram representing components of a memorial system consistent with the present invention;

FIG. 5 is a schematic block diagram illustrating a flow of content from a client into a memorial system;

FIG. 6 is a schematic block diagram illustrating transfer of information from a client to a memorial system;

FIG. 7 is a schematic block diagram illustrating connections between memorial system clients and an IM provider;

FIG. 8 is a schematic block diagram illustrating a system in which interactive memorial methods and systems are practiced;

FIG. 9 is a flow diagram representing an interactive process for authenticating a user of an interactive memorial system;

FIG. 10 is a flow diagram representing a process for deploying a drifter for use in connection with an interactive memorial;

FIG. 11 is a schematic block diagram illustrating a network in which an embodiment of the multimedia memorial system is practiced; and

FIG. 12 is a schematic representation of an exemplary IM user interface, display.

### DETAILED DESCRIPTION

The present invention includes incorporating a data base processor with optional monitor into a traditional headstone or other commemorative object whereby a person can pre-record messages to family members and others before death and have such messages activated at the grave site via the interactive display associated with the headstone. Solar panels can be incorporated into the headstone to provide power to the data base processor, optional monitor and other electronic equipment associated with the device, and a backup battery supply can also be incorporated into the headstone. The data base processor, when appropriately activated, will deliver pre-recorded messages and/or videos from the deceased at specific dates for different individuals, each individual having the capability of selecting the appropriate message and/or video designated specifically for that individual. Through an interactive display associated with the headstone or other commemorative object, the person could select and activate, such as from a menu, one or more pre-recorded messages including photographs of individuals and/or events, or family memorabilia such as fishing lures, baby shoes, etc.

Importantly, the data processor will store and provide for selection at the appropriate time, certain play back messages at specific dates programmed into the message delivery system. For example, if a birthday message is left for an individual five years from now, the message can be programmed into the system and it will only become available for selection via a menu or other selection vehicle at a certain date programmed into the system. Prior to that date, that particular message will not be available for selection. Other variations on this theme are likewise recognized and anticipated. The present system can include both audio and/or video.

The present invention can likewise be incorporated into a mausoleum type environment. Still further, another aspect of the present invention is the method in which the recording of the messages can take place. It is envisioned that the messages can be transmitted via a personal computer or some other communication system to a central location where the messages including video can be stored onto a chip and then the entire system can be incorporated into a headstone at the appropriate time. Also, it is envisioned that the headstone could be sized and shaped to incorporate the necessary components of the present system and such headstone could be made out of a wide variety of different materials.

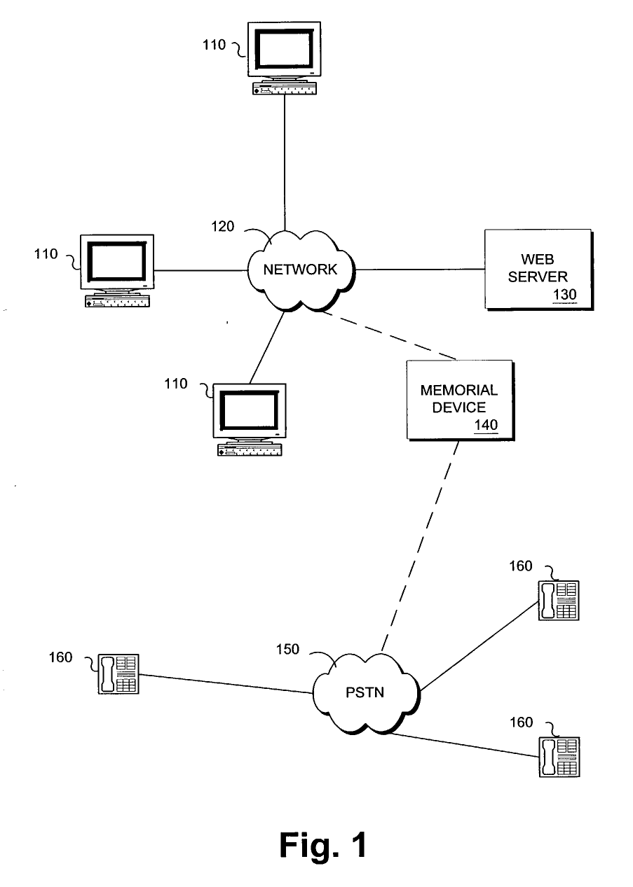

Referring now to the drawings, FIG. 1 illustrates a block diagram of a network in which methods and systems consistent with the present invention may be practiced. In one embodiment, a data network 120, such as, for example, a global computer network, e.g., the Internet, is used to facilitate communication between users of a an interactive multimedia memorial system. Users of the system use network terminals 110 to connect through the network to at least one memorial device 140. In an exemplary embodiment, web server 130 is a host computer that is connected to the global computer network, e.g., Internet, by way of a network connection, such as digital subscriber line, frame relay, a wide area network connection using existing land-based telecommunications infrastructure. Alternatively, web server 130 is connected to the network via a wireless networking protocol. Memorial device 140 is also connected to network 120 using a network connection. In the exemplary embodiment, the network connection associated with memorial device 140 is implemented using a wireless network connected memorial system.

Network node 110 may be of any type of data processing system capable of interacting with a network based application, including conventional personal computer (“PC”) type computer systems that are available from companies such as Hewlett-Packard Company and Dell Computer Corporation, employing an operating system such as, for example, the Linux operating system, which is available from companies such as Red Hat, Inc. or the Windows operating system, which is available from the Microsoft Corporation.

Network node 110 may alternatively be a UNIX workstation such as those available from Sun Microsystems and Silicon Graphics Inc. or the type of computer sold under the trademark Macintosh™ by Apple Computer Corporation. As will be apparent to one of ordinary skill in the art, in alternative embodiments, computers 110 may also be implemented using other types of computing platforms including thin clients, such as, for example, network computers or using personal digital assistants (“PDA”), such as, for example, the iPAQ™ from Compaq Information Technologies Group, L. P., having a place of business at 20555 State Highway, 249 Houston Tex. 77070. It will also be apparent to one of ordinary skill that network node 110 may be equipped with multimedia user interfaces including video displays, cameras, microphones, and speakers.

In the exemplary embodiment, users of network node 110 use a multimedia interface to compose video, audio-visual information, audio, text, or image based messages in ways that will be understood, for example, audio may be sampled into acceptable audio message formats including the Moving Picture Experts Group audio layer three (“MP3”) format, Real Audio™ formats, or the WAV format. It is understood that audio visual and image formats include, but are not limited to, MPEG, JPEG, AVI, Real Video™, Macromedia Flash™, GIF.

The recorded content may then be delivered to a memorial system provider via various means. In the exemplary embodiment content is provided: (i) by shipping of physical media; (ii) by electronic mail; and (iii) by Internet file transfer. When shipped on physical media, content is recorded by a client and saved to magnetic or optical storage media such as floppy disk, CD-ROM, DVD, Zip disk, or magnetic tape. Consistent with the present invention, newly developed physical information storage media may be used with the invention without departing from the scope of the invention.

When provided by electronic mail, content is attached to or included with an E-mail message. Commercial and non-commercial software has the ability to encode binary content using Multipurpose Internet Mail Extensions (“MIME”), Unix to Unix Copy (“UUCP”), or American Standard Code for Information Interchange (“ASCII”) conversions in connection with the standard Simple Mail Transfer Protocol (“SMTP”) or other proprietary ways of including binary attachments with E-mail messages for delivery to the memorial system provider.

When content is delivered via network file transfer such as Internet file transfer it is delivered from the client to memorial system 140 using various techniques, including being transferred through an intermediary host, such as, for example, web server 130 using the Hypertext Transfer Protocol (“HTTP”). Content may also be provided directly to memorial system 130 using a protocol such as for example HTTP or the File Transfer Protocol (“FTP”). Alternatively, peer to peer protocols such as GNUTELLA™ or FREENET™ may also be used to transfer message content.

The composed messages are then transmitted to web server 130 for storage and/or indexing for scheduled transmission to memorial device 140. In an alternative embodiment, message information may be transmitted to memorial device 140 directly from network node 110.

In the exemplary embodiment messages may also be composed using the public services telephone network, by way of a user of the memorial system placing an ordinary telephone call. In one embodiment, a user dials a telephone number associated with memorial device 140. In this embodiment, memorial device 140 is connected to the Public Services Telephone Network (“PSTN”) 150 by way of conventional wireless telephone service 160. Memorial device 140 receives the call and provides an interactive voice recognition or touch-tone menu system. After selecting an appropriate menu option, a user may speak or otherwise produce an audio message that is recorded in memorial device 140. Additionally, the user may speak or enter scheduling information regarding the message or accept default scheduling parameters associated with the menu option.

In another embodiment, a user provides multimedia message information directly to memorial device 140. In this case the user will experience a welcome message on a touch-screen LCD display. The message will provide the user with various options including, for example, (i) identify yourself to the system; (ii) view instructional help on using the system; and (iii) select a language for interacting with the system.

If a user chooses to identify himself or herself to the system, he or she will be prompted to provide authentication information, which is used to identify an individual, usually based on a username and password or credentials, however it is understood that other methods of authentication may be employed without departing from the scope of the present invention, including digital certificates, token cards, voice recognition, and other types of biometrics. An authenticated user is a user that has provided adequate credentials to an authentication system, based on a predetermined standard for adequacy of credentials, where predetermined means determined at any time before a particular authentication action. In one embodiment, the user will be provided with a virtual keypad on the touch-screen LCD, on which the user will be able to tap out with a stylus a sequence of characters, including, for example, a username and password.

If a user chooses to view instructional information he or she will be provided with information regarding how to use the system. And if the user elects to use a language other than a default language, such as English, then the selected alternative language will be used to interact with the user.

If the authenticated user is the owner or maintainer of the system he or she will be provided an opportunity to record messages directly into the memorial device 140. For example, a person that obtained a headstone or mausoleum in anticipation of his or her eventual death could go directly to the device located near the cemetery plot to directly record and schedule messages. In fact, an owner of the memorial device could record and schedule messages for a time before his or her death. And further, an owner of the memorial device 140 could test the system in order to observe how his or her messages look and sound.

When a user of the memorial device 140 authenticates as a user or person for whom messages have been recorded and scheduled, then the user is provided with a different set of messages. The messages may include, for example, (i) listen to welcome messages; (ii) listen to memorial audio; (iii) view memorial photos; (iv) view memorial video; and (v) list special event dates; and (vi) account maintenance functions, such as, for example change the password, change the e-mail address for notification messages, etc. In one embodiment, users are also provided with touch-screen buttons to adjust the level of contrast, brightness, and audio volume.

If the surviving user selects an option associated with the activity of listening to an audio clip, associated audio clips are played, and optionally, the user is provided with accompanying textual messages and photographs which the user is able to scroll through using touch-screen scroll buttons or scroll bars in connection with displayed text and images.

If the user selects the option to view special event dates, he or she is provided with a predefined list of special events. In connection with some of the special events there may be preprogrammed multimedia messages, which are configured to be accessible before the date of the special event, on the date, after the date, or a combination thereof based on the scheduling information provided by the maintainer of the memorial system.

Once a user is authenticated, he or she is provided with a custom menu that is personalized based on information provided by the person who configured the multimedia system, for example, the deceased person.

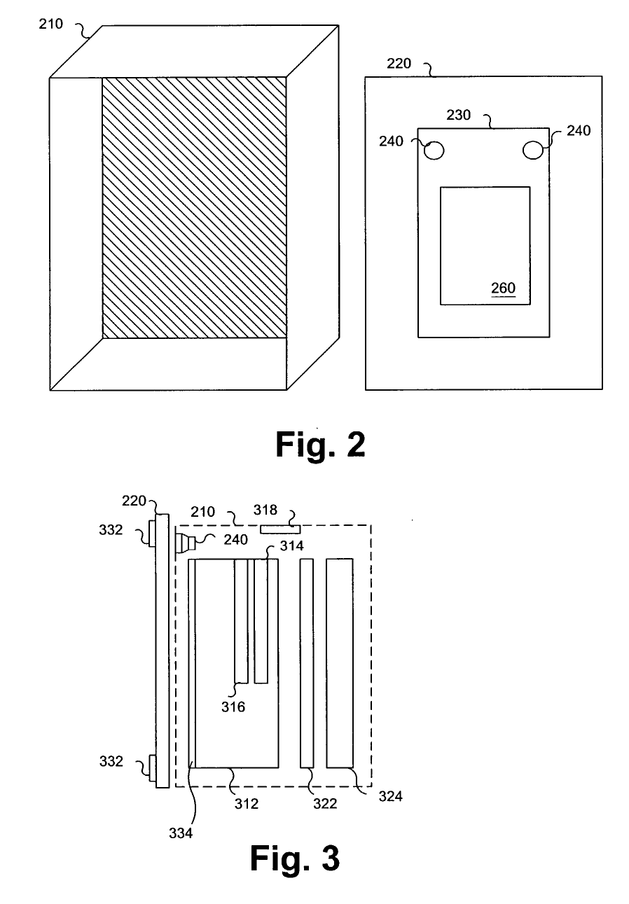

FIG. 2 illustrates a schematic diagram of an exemplary enclosure and an associated enclosure face. Enclosure 210 is preferably constructed out of stainless steel, but it is understood that other materials can be used. Enclosure face 220 preferably has a sealing door 230 that can be opened to expose display and user interface 260. In one embodiment, audio is used in connection with the memorial device and speakers 240 are used to produce sounds in connection with images and video produced in connection with the display and user interface 260.

FIG. 3 illustrates a sectional side diagram of one embodiment, including exemplary contents of the enclosure. The enclosure 220 is illustrated from the side to show photovoltaic cells 332. The speaker 240 is also shown in profile near the upper portion of enclosure 210. A heating strip 334 is shown on the front surface of PDA 312 that provides the display 260. A memory device 316 is shown in connection with the PDA 312. Further, a network interface 314 is shown in connection with the PDA 312. Thermostat 318 is optionally used to control the temperature associated with the display 260 using the optional heat strip 334. An optionally rechargeable battery 324 is provided to provide power to the electrical components associated with the memorial system of the present invention. Power conditioning module 322 is coupled with the photovoltaic cells 332 and battery 324 to provide a properly conditioned charging source for the battery 324. The power conditioning module 322 can optionally provide regulated power directly to the PDA 312.

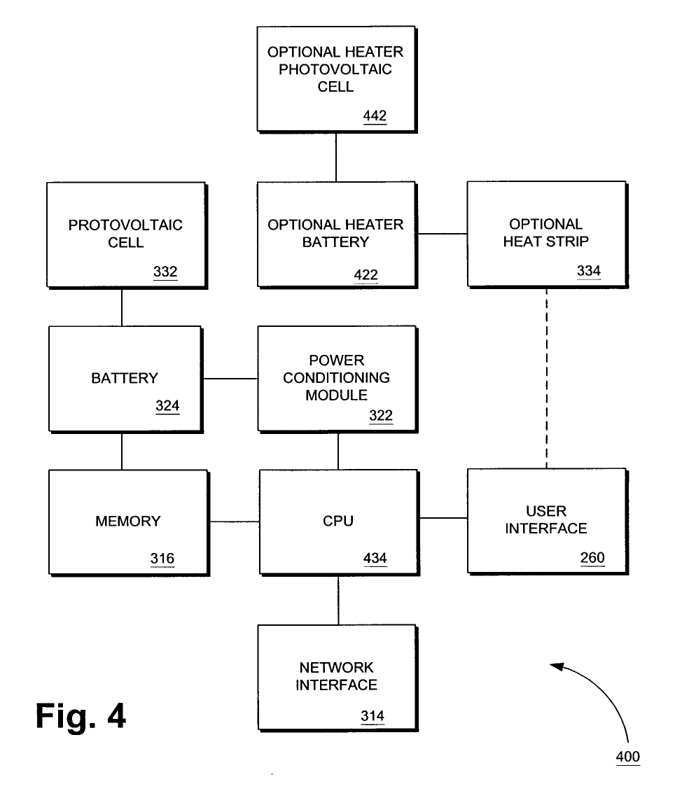

FIG. 4 illustrates a block diagram representing the electrical components of a memorial system consistent with the present invention. In one embodiment, memorial system 400 includes various elements that provide an ability to transmit information to survivors specified by a person before his or her death. In alternative embodiments, various components may be omitted or substituted without departing from the scope of the invention as claimed. In one exemplary embodiment, photovoltaic cell 332, such as solar panels available from Photon Technologies, Inc. of Severna Park, Md. is used to provide electrical power as generated from light energy sources, such as, for example, the sun. In alternative embodiments, electrical power may be obtained from other known sources, for example, from a municipal power grid or a stand-alone power generator. In this embodiment, power conditioning module 322, such as Multi-Chemistry Switching Charger Development System available from Texas Instruments Incorporated, conditions the electrical power received from the photovoltaic cell 332. In an alternative embodiment, power conditioning board functionality is incorporated directly into a computer unit in connection with CPU 434. In this embodiment, a power management integrated circuit, such as the bq200 programmable multi-chemistry fast-charge management integrated circuit available from Texas Instruments Incorporated is employed in and directly integrated with the CPU 434.

In one embodiment, photovoltaic cell 402 is made out of a flexible material, such as, for example, plastic substrate solar cells. Rechargeable battery 324 is also connected to power conditioning module 322. In one embodiment, the rechargeable battery 324 is a lithium polymer 950 mAh rechargeable battery such as those for use in connection with portable consumer electronic devices. Connected to the above-described power source are the memory device 316, central processing unit 434, user interface 260, and network interface 314. In one embodiment, user interface 260 is a touch-screen LCD, including a handwriting recognition module (not shown), that is maintained at a sufficiently warm temperature to operate properly using an optional heat strip 334 that is optionally powered by an optional heater battery 423. The heater battery 423 can be powered by an optional photovoltaic cell 442, which may be implemented using and can be coupled with photovoltaic cell 332 and/or power conditioning module 322 to generate heat from electrical power.

The memory 316 may be a solid-state or mechanical data storage device such as, for example, Personal Computer Memory Card International Association (“PCMCIA”) flash cards, such as those available from the International Business Machines Corporation, having an ability to communicate to a host system using a protocol such as, for example, the Advanced Technology Attachment (“ATA”) protocol. Alternatively, memory may be implemented using a small mechanical hard drive or other storage device technologies.

Central processing unit 434, which has the ability to read and write information from and to memory 316, may be implemented using various processor devices, for example, microprocessors from Intel Corporation, Motorola, Inc., Sun Microsystems, Inc., and Compaq Computer Corporation. In one embodiment, central processing unit is a StrongARM microprocessor, such as that used in connection with the Compaq iPaq™ pocket PC product. Coupled with the central processing unit user is interface 260. In alternative embodiments, other user interfaces can be used instead of a color LCD display as described in connection with an exemplary embodiment. Specifically, other types of displays can be used. Similarly, instead of a touch screen for an input device other forms of input devices can be used including a keyboard, keypad, mouse, digitizer, tablet, voice recognition system or image/motion detection system.

Furthermore, coupled to central processing unit 434 is network interface 314 which, in alternative embodiments, employs a number of technologies to enable coupling of central processing unit 434 to a network. Examples of such network interface include modems, network cards, such as Ethernet network cards. In further alternative embodiments, wireless network interfaces are employed using protocols such as Bluetooth, IEEE 802.11a, IEEE 802.11b or various conventional wireless telephone standards such as AMPS, NAMPS, TDMA, CDMA, or GSM in connection with a modem.

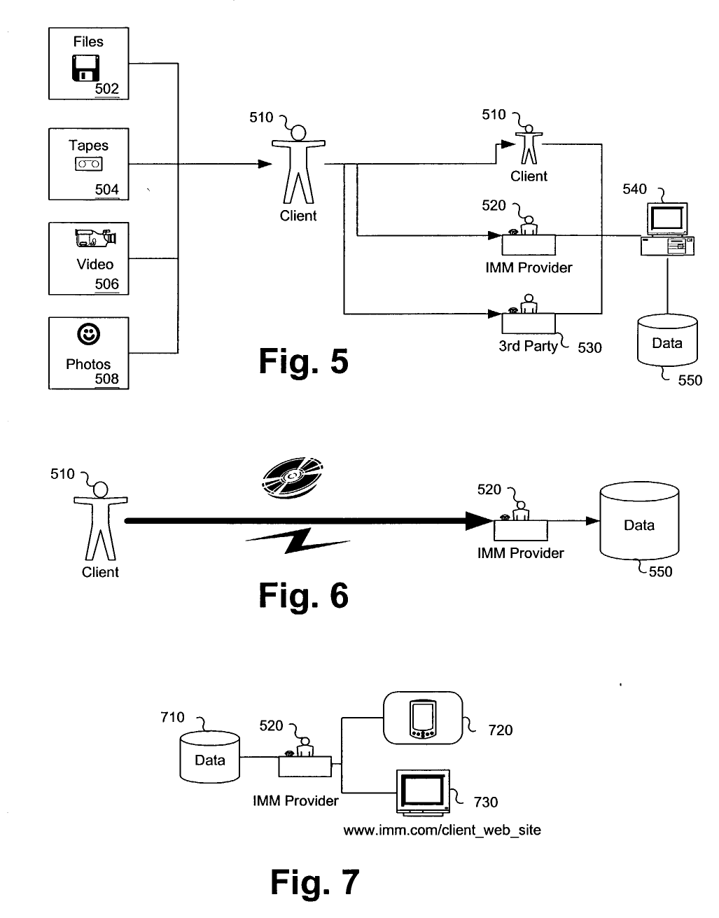

FIG. 5 is a schematic block diagram illustrating a flow of content from a client into a memorial system. In one embodiment, client 510 gathers and organizes multimedia content and other information for use in connection with an Interactive Memorial (“IM”) system. In order to provide multimedia content to a designated person at a scheduled time after the death of an owner of an interactive memorial system, multimedia content is provided by the owner of the memorial system. Specifically, the multimedia content takes the form of audio messages or sounds, for example, a recorded monologue or a recorded. Audio content may also include music or recordings of nature. Additional multimedia content includes photographic images and video.

Content is loaded into memorial devices by way of a computer connected via an serial connection such as, for example, an RS 232-C connection or Universal Serial Bus (“USB”) connection that is compatible with a PDA as used in connection with the exemplary embodiment. Transfer of content files may be performed, for example, using MICROSOFT® ActiveSync™ or Palm Computing, Inc.'s HotSync® software. Infrared and wireless connectivity may also be used alternatively to a direct electrical connection as used in connection with for example USB. Bluetooth and IEEE 802.11a and/or IEEE 802.11b are also supported for transferring content from a computer such as a laptop to the memorial device.

The multimedia content is accepted in a number of formats, including as files on magnetic media, such as floppy diskettes 502 containing files, or CD-R disks. Additionally, audio materials may be provided on a standard audio cassette tape 504 or micro-cassette tapes. Video 506 may be provided on standard magnetic media such as VHS tapes or other current or subsequently developed video recording media. Further, photos 508 are accepted to be scanned and made into photographic images.

These media are produced or received by client 510 and aggregated or converted into digital format and stored as data 550 in a storage medium associated with computer system 540. In one embodiment, content is either provided directly to computer system 540 by client 510. Alternatively, client 510 provides multimedia content to IM provider 520, who then causes the multimedia content to be stored as data 550 on the storage medium in connection with computer system 540. In yet another embodiment, a third party 530 is retained for the purpose of converting (if necessary) and storing the multimedia content as data 550.

FIG. 6 is a schematic block diagram illustrating transfer of information from a client to a memorial system. In the illustrated embodiment, client 510 provides a CD-R disk to IM provider 520, which contains multimedia content that the IM provider 520 transfers and stores as data 550. In one embodiment, the client accesses an IM web site to arrange memorial information, to choose an IM device, and to select IM web site and data retention options.

FIG. 7 is a schematic block diagram illustrating an embodiment including connections between memorial system clients and an IM provider. In this embodiment, personal digital assistants 720, (“PDA”) are used to connect to systems provided by IM provider 520. In this embodiment, IM provider 520 provides access to data 710, which contains memorial information. Client computer system 730 also accesses data 710 by way of IM provider 520. In one embodiment access to data 710 is provided via a web server having an address of the form www.Domain Name.com/client_web_site. In one embodiment, PDA 720 is integrated into an IM device and the IM device is used to produce memorial content and/or to load memorial content into the IM device.

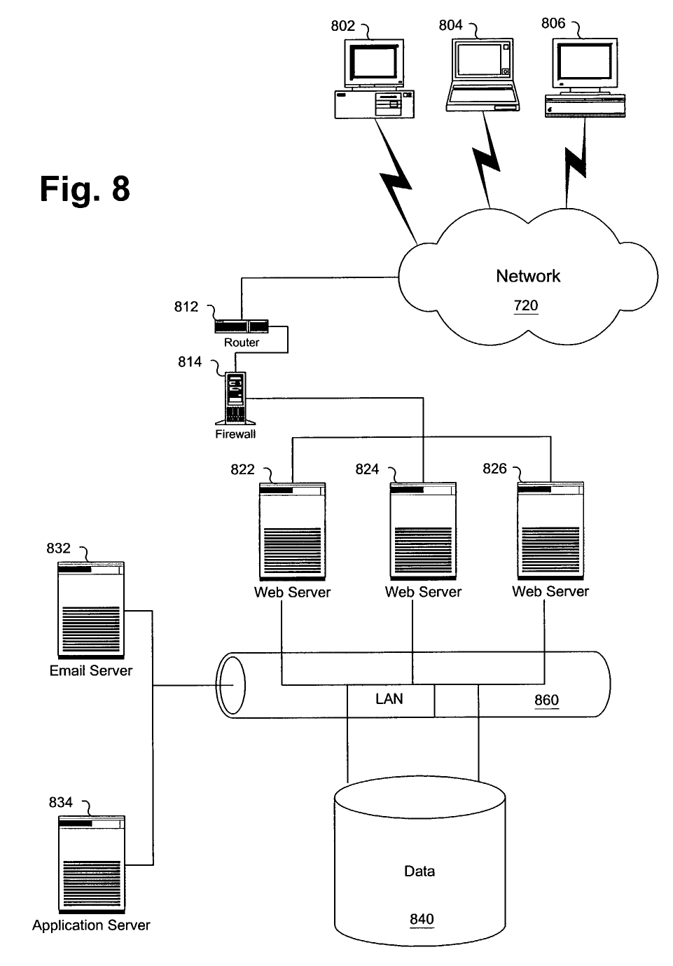

FIG. 8 is a schematic block diagram illustrating a system in which interactive memorial methods and systems are practiced. In one embodiment, a pull model is employed. In this embodiment, a user accesses an IM client Uniform Resource Locator (“URL”) by way of a standard web browser application such as the standard browser application used on computer systems 802, 804, and 806. The user connects to web servers 822, 824 and/or 826 through a network, such as Internet 720. Network traffic is optionally transferred through router 812 and firewall 814 to web servers 822, 824 and/or 826.

Next the IM web site by way of web server 822, 824 and/or 826 determines whether the user connecting through one of computer systems 802, 804, or 806 transmits an encrypted logon cookie. If the user's browser application does not present an appropriate cookie to web server 822, 824 and/or 826 then the user's browser is redirected to a logon page. If the user is redirected to the logon page, the user signs onto the web site, using a userid and password, or a userid and hardware token or other identification tokens. It will be understood that alternative user authentication mechanisms may be employed without departing from the scope of the invention.

Once a user is authenticated, the user is presented with a main menu of the client web site, from which memorial messages can be selected for viewing and/or hearing. Finally, a user selects particular memorial messages. In this embodiment, a user can access information from any global computer network, e.g., the Internet, computer anywhere in the world. Information can be repeatedly accessed in a secure, backed-up and reliable data center, without worry of local data loss or corruption. Furthermore, IM data can be made whether public, by way of a global computer network, e.g., Internet, or private, by enforcing authentication and authorization, as the memorial owner or his or her designated trustee desires.

In this embodiment, web servers 822, 824 and/or 826 provide data 840 to client computers 802, 804, and 806 by communicating with application server 834 over Local Area Network (“LAN”) 860. In one embodiment, data 840 is provided in by a relational database server, such as an Oracle™ server or the MICROSOFT® SQL Server product. In one embodiment, memorial content may be stored into data 840 by being sent through E-mail server 832. Alternatively, E-mail server 832 may be used to provide memorial information at predetermined times by sending the memorial information out to intended recipients by way of an E-mail message.

In an alternative embodiment, a push and pull method is employed. In this embodiment, an IM system scans a database associated with an IM provider at a predetermined interval such as hourly or daily to determine if a specific event needs to be performed. In one embodiment, if the IM system determines that a date specific message needs to be sent, a URL to the message is E-mailed to the current E-mail address of the intended recipient of the date specific message. Upon receipt of the message containing the URL, the user connects to web server 822, 824 and/or 826, authenticates and accesses memorial information as described in connection with the pull model. In this embodiment, the user is actively reminded to view the IM memorial message, by way of the E-mail. The push and pull method has the benefit of providing reminders about date specific memorial message. Accordingly, the overall IM system is highly adaptive and provides specific messages at times specified by the deceased owner of the IM system.

In yet another alternative embodiment, a push model is employed. In this embodiment, an IM system scans a database at a predetermined interval to identify date or time specific events. In response to identifying a date or time specific event, an IM message is E-mailed as an attachment to the registered E-mail address of the intended recipient, as specified by the deceased owner of the IM system. Upon receipt of the E-mail message, the user accesses the memorial content by opening the attachment to the E-mail message.

In this embodiment, the user is actively reminded to view the IM memo. Further, by specifying date or time specific events and associated memos, the owner of an IM system has the ability to make available to intended recipients specific information or memos only at specific dates and times. In this embodiment, content is provided directly to the recipient's local computer by E-mail. Depending on the type of network connection of the intended recipient, accessing content locally can provide more efficient access to multimedia content that accessing the content over the Internet.

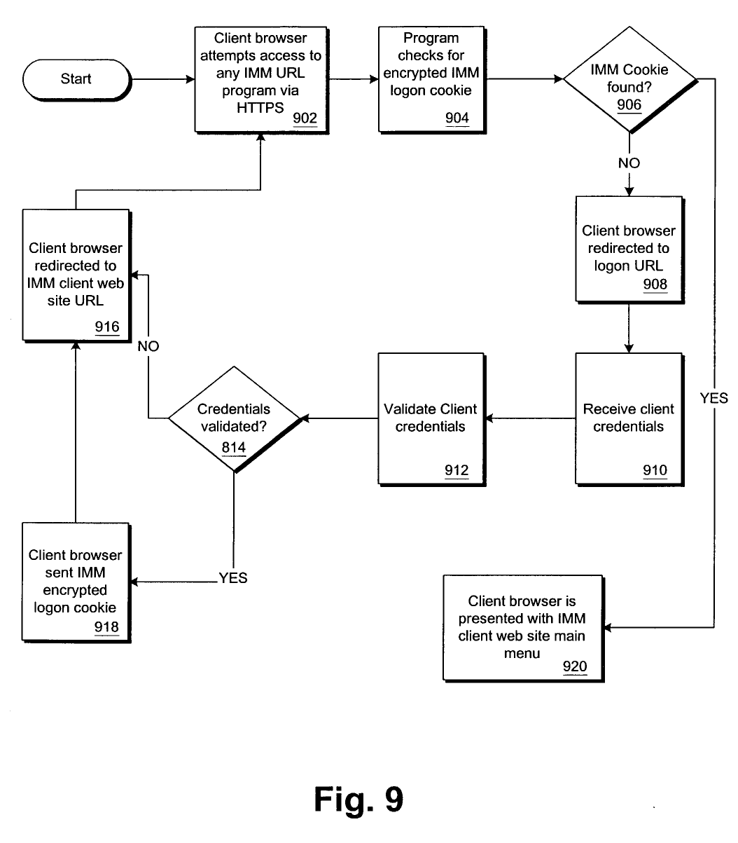

FIG. 9 is a flow diagram representing an interactive process for authenticating a user of an interactive memorial system. In order to facilitate multiple users of an IM system and to inhibit unauthorized access and tampering with an IM system, authentication and authorization systems and procedures are provided. In one embodiment, a client browser attempts access to any IM URL using the Secure Sockets Layer (“SSL”) by way of the Secure HTTP or HTTPS protocol (stage 902). Next, the IM program, by way of a web server checks for an encrypted IM logon cookie (stage 904). If the IM logon cookie is found (stage 906) then the client browser is presented with the IM client web site main menu (stage (920). If the cookie is not found, then the client browser is redirected to a logon URL (stage 908). Next, the IM web site receives client credentials (stage 910). Next, the IM web site validates the credentials (stage 912). Validating credentials is performed by comparing a provided userid and password to a stored and preferably encrypted password. Alternatively, credentials may be validated in other ways, using, for example a challenge response protocol, digital certificates in the context of a Public Key Infrastructure (“PKI”), or biometrics. If the credentials are successfully validated (stage 814) then the client browser is presented with an encrypted logon cookie that it presents to the IM web site to evidence current authentication. If the credentials cannot be validated, the client browser is redirected to the IM web site for additional information (stage 916). Finally, the user returns to (stage 902), where an authenticated user is provided access to contents of the web site, including memorial content, messages, and memos.

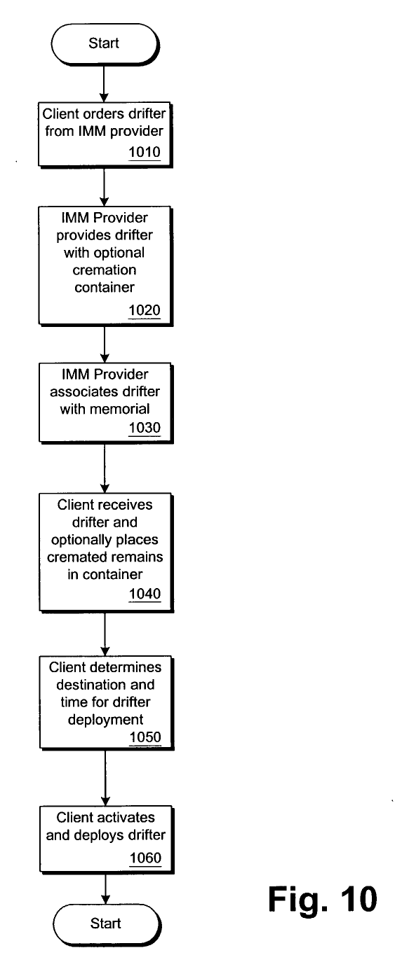

FIG. 10 is a flow diagram representing a process for deploying a device that includes Global Positioning System (“GPS”) transmitter. The preferred device is a drifter, for use in connection with an interactive memorial. In this embodiment, a client orders a drifter, from an IM provider (stage 1010). A drifter is a device designed to be deployed into a body of water, preferably an ocean, with Global Positioning System (“GPS”) information and a transmitter to provide GPS information for the purpose of tracking the drifter. Next, the IM provider provides a drifter, with an optional cremation container to the client (stage 1020). In the optional cremation container, cremated ashes of the deceased owner of the memorial system may be placed so that a person's remains may drift at sea, and the drifter provides GPS coordinates of the drifting remains. Next, the IM provider associates the drifter with a particular IM system (stage 1030). Next, the client receives the drifter and optionally places cremated remains into the container associated with the drifter (stage 1040). Next the client determines the destination and time for deploying the drifter (stage 1050). Finally, the client activates the drifter and deploys it, for example into an ocean by throwing it over the side of a ship that is out at sea (stage 1060).

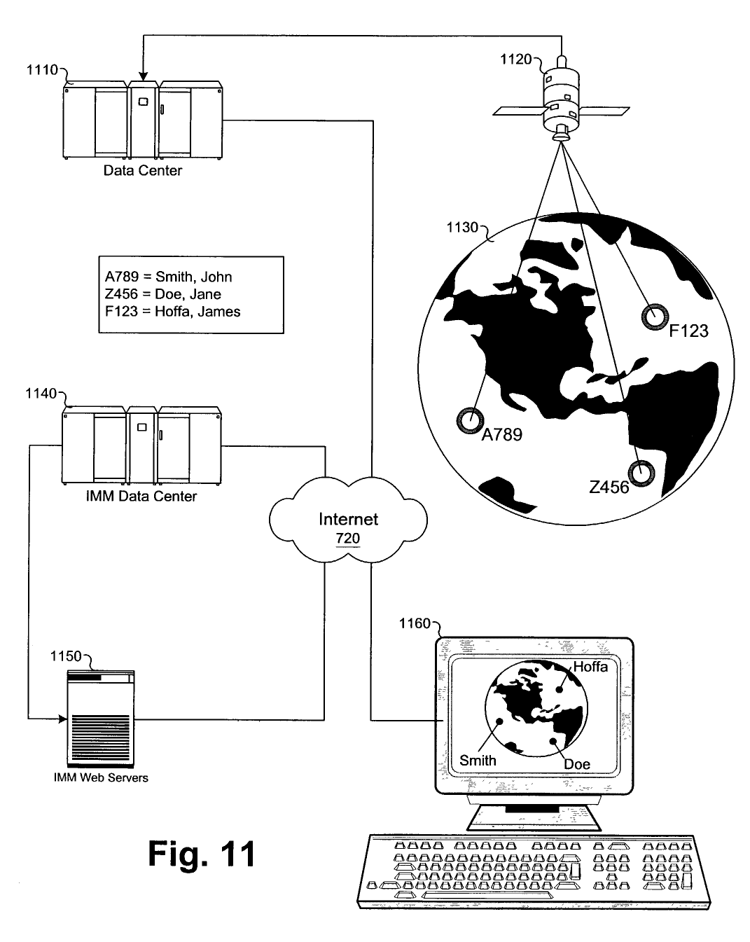

FIG. 11 is a schematic block diagram illustrating a network in which an embodiment of the multimedia memorial system is practiced. In one embodiment, a surviving user of an IM system may monitor one or more drifters associated with deceased persons. In FIG. 11 three deceased persons are illustrated, specifically John Smith, with associated identification number A789, Jane Doe, with associated identification number Z456, and Mark Jones with associated identification number Z123. In this embodiment, drifters associated with Smith, Doe, and Jones are deployed in the North Pacific, South Pacific, and the North Atlantic respectively. GPS satellite 1120, and other GPS satellites (not shown) transmit radio signals to Earth 1130 and to drifters associated with a deceased person. The drifters in turn transmit reply signals to satellite 1120. Alternatively the drifters transmit signals regarding their location to other radio receivers. Next, information regarding the position of the drifters is transmitted to a data center 1110 associated with an IM provider, such as the Service Argos, Inc, data center. Next, the data center 1110 provides the location information to an IM data center 1140 through the global computer network, e.g., Internet 720. Next the IM data center 1140 provides the location information to IM web server 1150, on a continual basis, or alternatively on demand. This information is provided by way of Internet 720 to client computer system 1160, which displays a geographical representation of the actual location of the drifters associated with the deceased persons.

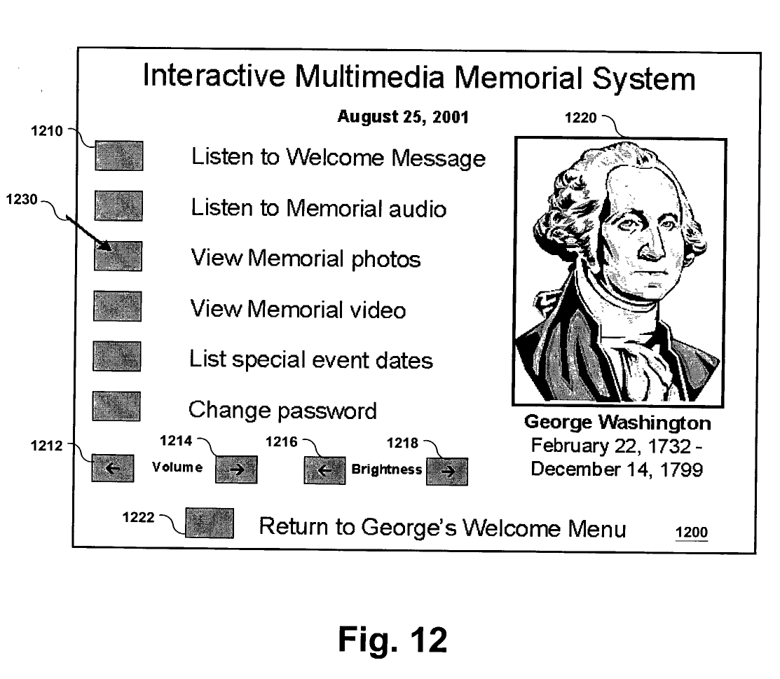

FIG. 12 is a schematic representation of an exemplary IM user interface display. An exemplary display 1200 is illustrated that identifies: (i) several buttons such as a button 1210; (ii) an image 1220; (iii) and a pointer 1230. The button 1210 is an exemplary button that can be selected to cause the execution of a corresponding menu option, such as “Listen to Welcome Message” as shown in connection with the button 1210. The button 1210 is preferably implemented as a shaded region on the touch screen of a PDA that can be selected by the clicking of a stylus. In an alternative embodiment, the button 1210 is an icon that is selected using a pointing device, such as a mouse. In one embodiment, the pointer 1230 is used to indicate which menu option is being selected. In one embodiment, audio volume is increased by clicking on a button 1212 and decreased by clicking on a button 1214. Further, display brightness is adjusted using buttons 1216 and 1218. A button 1222 is used to return to a menu other than exemplary display of FIG. 12. It is understood that other buttons and types of user interface design can be employed without departing from the scope of the present invention.

1. An electronic system for storing and providing memorial information, the system comprising:
an enclosure having at least one opening;
an interactive user interface contained within the enclosure; and
a processor electrically connected to the interactive user interface and contained within the enclosure, wherein the processor is configured to receive message information having associated playback-event information, including an associated playback event, and the processor is configured to provide the message information via the interactive user interface upon an occurrence of the associated playback event, wherein at least a portion of the message information operates as a commemorative memorial.

2. The electronic system according to claim 1, further including a solar panel electrically connected to the processor.

3. The electronic system according to claim 1, wherein the enclosure is portable.

4. The electronic system according to claim 1, wherein the interactive user interface includes a Personal Digital Assistant with a touch screen for receiving user input and for providing video output, wherein the Personal Digital Assistant further includes an audio output that is electrically connected to a loudspeaker.

5. The electronic system according to claim 1, wherein the message information includes audiovisual streaming video.

6. The electronic system according to claim 1, wherein the message information includes audio information.

7. The electronic system according to claim 6, wherein the audio information includes a voice message recorded in a digital format.

8. The electronic system according to claim 7, wherein the digital format is selected from the group consisting of a Moving Picture Experts Group audio layer three format and a WAV audio format.

9. The electronic system according to claim 1, wherein the associated playback event is the occurrence of a birthday.

10. The electronic system according to claim 1, wherein the associated playback event is the occurrence of a wedding anniversary.

11. The electronic system according to claim 1, further including a portable device that includes a Global Positioning System transceiver unit for providing geographical location information and a Global Positioning System receiver unit that is electrically connected to the interactive user interface that is able to provide position information related to the portable container that is available through the interactive user interface.

12. The electronic system according to claim 11, wherein the portable container is capable of holding cremated remains.

13. An electronic system for storing and providing memorial information, the system comprising:
a data center for storing and providing remote access to memorial information;
an interactive electronic device, which includes an interactive user interface, wherein the data center is connected to the interactive electronic device through an electronics communication network; and
a processor that is electrically coupled with the interactive electronic device, wherein the processor is configured to receive memorial information, the memorial information having associated playback-event information, including a playback event, wherein the processor provides the memorial information via the interactive user interface upon an occurrence of an associated playback event, wherein at least a portion of the memorial information operates a commemorative memorial.

14. The electronic system according to claim 13, wherein the interactive user interface includes an audio-visual output.

15. The electronic system according to claim 13, wherein the memorial information includes audio-visual content.

16. The electronic system according to claim 13, wherein the memorial information comprises includes audio content.

17. The electronic system according to claim 16, wherein the audio content comprises a voice message recorded in a digital format.

18. The electronic system according to claim 17, wherein the digital format is selected from the group consisting of a Moving Picture Experts Group audio layer three format and a WAV audio format.

19. The electronic system according to claim 13, wherein the playback event is the occurrence of a birthday.

20. The electronic system according to claim 13, wherein the playback event is the occurrence of a wedding anniversary.

21. The electronic system according to claim 13, further including a portable device that includes a Global Positioning System transceiver unit for providing geographical location information and a Global Positioning System receiver unit associated with the portable device that is able to provide position information related to the portable container that is available through the interactive user interface.

22. The electronic system according to claim 21, wherein the portable container is capable of holding cremated remains.

23. A method for storing and providing memorial information, the method comprising:
providing an enclosure having at least one opening;
providing an interactive user interface contained within the enclosure; and
providing a processor electrically connected to the interactive user interface and contained within the enclosure;
receiving message information having associated playback-event information, including an associated playback event; and
providing the message information via the interactive user interface upon an occurrence of the associated playback event with the processor, wherein at least a portion of the message information operates as a commemorative memorial.

24. The method according to claim 23, further including:
receiving input to the interactive user interface with a pressure sensitive membrane; and
providing an audio-visual output to the interactive user interface.

25. The method according to claim 23, further including:
receiving authentication information from the interactive user interface; and
providing the message information on the interactive user interface based on the authentication information.

26. The method according to claim 23, wherein the message information is provided in the form of an e-mail message.

27. The method according to claim 23, further including receiving Global Positioning System location information that is displayed on the interactive user interface.

28. The method according to claim 27, wherein the Global Positioning System location information is associated with a container that is capable of containing cremated remains of the deceased person.
